(19) United States
(12) Patent Application Publication
(10) Pub. No.: US 2026/0023596 A1
(43) Pub. Date: Jan. 22, 2026

(54) APPARATUS AND METHOD FOR INTERFERENCE PREDICTION AND GUARANTEE OF GPU SHARING FOR DISTRIBUTED DEEP LEARNING JOBS

(71) Applicant: KOREA UNIVERSITY RESEARCH AND BUSINESS FOUNDATION, Seoul (KR)

(72) Inventors: Changyong SHIN, Seoul (KR); Younghoon GO, Seoul (KR); Yeonho YOO, Suwon-si (KR); Gyeongsik YANG, Seoul (KR); Hyuck YOO, Seoul (KR)

(21) Appl. No.: 19/040,814

(22) Filed: Jan. 29, 2025

(30) Foreign Application Priority Data
Jul. 16, 2024 (KR) 10-2024-0093797
Jan. 15, 2025 (KR) 10-2025-0006360

(51) Int. Cl. G06F 9/48; G06F 9/54

(52) U.S. Cl. CPC G06F 9/4881; G06F 9/54; G06F 2209/548

(57) ABSTRACT

Disclosed herein is an apparatus and method for interference prediction and guarantee of GPU sharing for distributed deep learning jobs. There is provided a scheduling method performed by a computing device, according to an embodiment. The scheduling method includes: receiving a distributed training job (DT job) from at least one user to register the DT job in a scheduling queue; generating candidate DT job combinations by filtering multiple DT job combinations, each consisting of one pre-scheduled first DT job in one of GPUs included in a GPU cluster and one of the DT jobs registered in the scheduling queue; and selecting a DT job to be executed concurrently with the first DT job in the one of the GPUs.

### CROSS-REFERENCE TO RELATED APPLICATION

This application claims priority under 35 U.S.C § 119 to Korean Patent Application No. 10-2024-0093797 filed in the Korean Intellectual Property Office on Jul. 16, 2024, and Korean Patent Application No. 10-2025-0006360 filed on Jan. 15, 2025, the entire contents of which are hereby incorporated by reference.

### BACKGROUND OF THE INVENTION

### Field of the Invention

The present invention relates to scheduling of deep learning jobs that predicts the degradation in speed caused by interference that occurs when two distributed deep learning jobs share a GPU in a GPU cloud, and further guarantees speed degradation. More specifically, the present invention relates to a method of searching and scheduling deep learning job combinations (pairs) that predicts interference based on the GPU resource profiling results of distributed deep learning jobs, such as GPU core utilization and GPU memory bandwidth utilization, and guarantees training speed degradation while mitigating interference when the GPU is shared.

### Description of the Related Art

### Distributed Deep Learning (DDL)

Recently, the parameter size of deep learning models has become enormous in order to achieve high accuracy and versatility, and large language models (LLMs) such as ChatGPT are being utilized in various fields. To train deep learning models with large-scale parameters, multiple GPUs may be used to enable distributed processing of the deep learning model's training. Therefore, the training speed of the deep learning model may be accelerated, or the training of deep learning models that were impossible on a single GPU may be made possible.

Distributed deep learning training is categorized into a method that distributes the training data and a method that distributes the deep learning model. In case of distributing the data, since the same deep learning model is trained on multiple GPUs, the process of synchronizing the training results is inevitably required. There are two synchronization methods, which are the parameter server (PS) method, where the training results are collected centrally and then distributed to each GPU, and the all-reduce method, where each GPU shares its training results with the others.

### GPU Cloud

In general, the cloud refers to a computing form that operates large-scale computing resources and provides services that automate the utilization of computing resources, allowing users to rent the required computing resources as needed. The services are categorized into SaaS (Software as a Service), IaaS (Infrastructure as a Service), PaaS (Platform as a Service), and others, depending on the type of computing resources provided by the cloud.

Recently, with the high-cost GPU resources becoming essential for deep learning model training, cloud-based model training has become very active. Cloud computing providers such as Google Cloud Platform, Microsoft Azure, and Amazon Web Services receive users' deep learning jobs and execute the jobs using the GPUs they possess. In this case, each user submits the requirements of the deep learning job (such as the number of GPU workers), and the GPU cloud scheduler schedules the deep learning job appropriately based on the information submitted by the user.

### GPU Sharing

The method of GPU allocation for distributed deep learning jobs varies depending on the cloud scheduler. Specifically, when executing a distributed deep learning job, the cloud scheduler has either 1) exclusive (dedicated) use of the GPU, or 2) shared use of the GPU. GPU exclusivity refers to the allocation of a GPU exclusively to a distributed deep learning job without sharing the GPU between jobs, and most public GPU clouds use this GPU dedicated use strategy. However, due to the dedicated use of the GPU, low average GPU utilization has been reported in public GPU clouds.

GPU sharing refers to multiple distributed deep learning jobs sharing and using a single GPU concurrently. However, GPU sharing causes a decrease in training speed and an increase in job completion time (JCT) compared to GPU exclusivity due to resource usage interference between concurrently running deep learning jobs. Additionally, the extent to which the JCT increases varies greatly depending on the characteristics of the distributed deep learning job, requiring careful consideration during job scheduling.

The definitions of the terms used in this specification are as follows.

JCT: Refers to the time from the initiation of the execution of the distributed deep learning job requested in the GPU cloud until the training is completed and the results are returned to the user who requested the job. When two or more distributed deep learning jobs share a single GPU, interference occurs in the use of GPU resources, which results in an increase in the JCT of each job.

gSLA (GPU Service Level Agreement): Defined as the upper threshold of the ratio between the JCT when executing a distributed deep learning job with GPU sharing and the JCT when executing with GPU exclusivity. For example, when the gSLA is set to 2, it means that the user accepts the JCT when the GPU is shared to increase up to twice that of GPU exclusivity.

GPU Time: Refers to the total duration of GPU usage required to complete the training of all enqueued distributed deep learning jobs of the GPU cloud. The smaller the GPU time value required to train the same distributed deep learning job, the higher the efficiency of the GPU infrastructure.

### SUMMARY OF THE INVENTION

The technical object to be achieved by the present invention is to point out that the degree of JCT increase due to interference when a GPU is shared varies significantly depending on which distributed deep learning job shares the GPU. To address this, the invention involves profiling the GPU resource usage of the distributed deep learning jobs to predict the JCT increase when two jobs share the GPU, and scheduling the jobs to ensure that a gSLA for each job is satisfied, thereby improving the gSLA satisfaction, JCT, and GPU time.

In existing related studies, to predict the level of interference between distributed deep learning jobs sharing a GPU, the GPU utilization or GPU memory utilization of the jobs was measured. In addition, it was found that when two jobs with high GPU utilization share a GPU, severe interference occurs, resulting in an increase in JCT. However, the JCT increase varies significantly depending on which distributed deep learning job shares the GPU, and this is referred to as JCT inconsistency. Since existing studies are unable to accurately predict the JCT increase, they fail to resolve the JCT inconsistency.

To solve the JCT inconsistency issue, the present invention introduces a gSLA that guarantees the upper threshold of the JCT increase caused when the GPU is shared. By developing and applying a scheduler that satisfies the gSLA, the problem of improving JCT inconsistency is transformed into a method of satisfying the gSLA.

There is provided a scheduling method performed by a computing device, according to an embodiment. The scheduling method includes: receiving a distributed training job (DT job) from at least one user to register the DT job in a scheduling queue; generating candidate DT job combinations by filtering multiple DT job combinations, each consisting of one pre-scheduled first DT job in one of GPUs included in a GPU cluster and one of the DT jobs registered in the scheduling queue; and selecting a DT job to be executed concurrently with the first DT job in the one of the GPUs.

The present invention predicts the JCT increase between two distributed deep learning jobs and proposes a scheduling algorithm and scheduler that ensures only two jobs that satisfy the gSLA share the GPU during the execution of distributed deep learning jobs. In this manner, the gSLA satisfaction can be improved, and the sum of the JCTs and the sum of GPU times for all jobs can be reduced.

Therefore, the present invention, through GPU resource usage profiling of distributed deep learning jobs and a deep learning-based interference prediction model, enables effective prediction of interference even without sharing the GPU for actual distributed deep learning workloads. In addition, through the present invention, the performance degradation caused by interference when the GPU is shared can be mitigated, making it possible to provide GPU sharing-based services on the GPU cloud and improving the GPU utilization of the GPU cloud.

### BRIEF DESCRIPTION OF THE DRAWINGS

Detailed description related to each drawing is provided to further sufficiently understand drawings cited in the detailed description of the present invention.

FIG. 1 illustrates an example of a GPU cloud and workflow.

FIG. 2 illustrates the distribution of JCT.

FIG. 3 illustrates the cumulative distribution function (CDF) of the JCT increase (δ).

FIG. 4 illustrates the ideal GPU time and the GPU time when the GPU is shared.

FIG. 5 illustrates the cumulative distribution function (CDF) of gSLA violations.

FIG. 6 illustrates the workflow of the proposed GPU sharing technique (TensorShare).

FIGS. 7A to 7C are views for explaining the limitations of GPU utilization through (a) an example of two job combinations, (b) DenseNet-40-12, and (c) TransformerBig.

FIGS. 8A and 8B are views for explaining input feature selection.

FIGS. 9A and 9B are views for explaining the job sensitivity of a DT job.

FIG. 10 illustrates a comparison of empty STA occurrences according to the technique.

FIG. 11 is a flowchart for explaining a scheduling method according to an embodiment of the present invention.

### DETAILED DESCRIPTION OF THE INVENTION

Disclosed hereinafter are exemplary embodiments of the present invention. Particular structural or functional descriptions provided for the embodiments hereafter are intended merely to describe embodiments according to the concept of the present invention. The embodiments are not limited as to a particular embodiment.

Various modifications and/or alterations may be made to the disclosure and the disclosure may include various example embodiments. Therefore, some example embodiments are illustrated as examples in the drawings and described in detailed description. However, they are merely intended for the purpose of describing the example embodiments described herein and may be implemented in various forms. Therefore, the example embodiments are not construed as limited to the disclosure and should be understood to include all changes, equivalents, and replacements within the idea and the technical scope of the disclosure.

Terms such as “first” and “second” may be used to describe various parts or elements, but the parts or elements should not be limited by the terms. The terms may be used to distinguish one element from another element. For instance, a first element may be designated as a second element, and vice versa, while not departing from the extent of rights according to the concepts of the present invention.

Unless otherwise clearly stated, when one element is described, for example, as being “connected” or “coupled” to another element, the elements should be construed as being directly or indirectly linked (i.e., there may be an intermediate element between the elements). Similar interpretation should apply to such relational terms as “between”, “neighboring,” and “adjacent to.”

Terms used herein are used to describe a particular exemplary embodiment and should not be intended to limit the present invention. Unless otherwise clearly stated, a singular term denotes and includes a plurality. Terms such as “including” and “having” also should not limit the present invention to the features, numbers, steps, operations, subparts and elements, and combinations thereof, as described; others may exist, be added or modified. Existence and addition as to one or more of features, numbers, steps, etc. should not be precluded.

Unless otherwise clearly stated, all of the terms used herein, including scientific or technical terms, have meanings which are ordinarily understood by a person skilled in the art. Terms, which are found and defined in an ordinary dictionary, should be interpreted in accordance with their usage in the art. Unless otherwise clearly defined herein, the terms are not interpreted in an ideal or overly formal manner.

Hereinafter, example embodiments will be described with reference to the accompanying drawings. However, the scope of the patent application is not limited to or restricted by such example embodiments. Like reference numerals used herein refer to like elements throughout.

Distributed training (DT) or distributed deep learning accelerates model training through multiple GPU workers and parameter servers (PSs). Here, a GPU worker refers to an entity that performs model training in a distributed manner. In general, DT is executed on a GPU cloud. FIG. 1 illustrates an example of a GPU cloud and workflow. Multiple users submit their desired DT jobs and designate the number of GPU workers required for the corresponding job. The submitted jobs are placed in a scheduling queue, and the cloud scheduler executes the corresponding job on GPUs.

The allocation of GPUs to DT jobs (or distributed deep learning job) varies depending on the cloud scheduler. Specifically, when executing the jobs, the cloud scheduler uses one of two approaches: 1) dedicated use and 2) GPU sharing. Dedicated use refers to allocating the GPUs exclusively to the DT jobs without sharing the GPUs. Most public GPU clouds use this dedicated use strategy. GPU sharing refers to the method of using the GPUs for multiple DT jobs concurrently, and due to sharing, interference occurs between the jobs, leading to a decrease in training speed.

First, the experimental setup is explained. Then, the experimental results for 1) JCT consistency, 2) GPU time, and 3) gSLA satisfaction are presented.

Setup. All experiments are conducted by connecting two GPU machines and one storage machine through a 10 GbE switch. Each of the two GPU machines is equipped with two NVIDIA V100 GPUs (a total of four GPUs). In addition, each of the two GPU machines has two Intel Xeon Silver 4210 CPUs and 128 GB of RAM. The storage machine is also equipped with two Intel Xeon Silver 4210 CPUs, 128 GB of RAM, and a 2 TB SSD. For the experiments, the DT job is set with two GPU workers and two parameter servers (PSs). The GPU workers and PSs may be executed as containers through Kubernetes.

The Kubernetes scheduler utilizes the Kubernetes plugin to enable GPU sharing for the GPU workers. In the experiment of the present invention, the Kubernetes plugin places a maximum of two GPU workers on a single GPU. Additionally, it is assumed that no bottlenecks or resource interferences occur. The storage machine stores the training datasets and the computational states of paused models (e.g., model parameters). The storage machine and GPU machines are connected by a network file system.

As DT jobs, representative image classification and natural language processing (NLP) deep learning models, as shown in Table 1, are used. Two types of datasets for image classification models (CIFAR-10 and ImageNet) and one dataset for NLP models (Europarl) are used. A total of 29 different DT jobs are configured with these models and datasets. Each DT job measures the JCT by repeating the forward propagation and backward propagation over 700 iterations. A batch size of 64 is used for image classification models, and a batch size of 128 is used for NLP models. The DT jobs is executed using TensorFlow 1.13, OpenNMT-tf 1.25.3, and Python 3.7, with CUDA 11.4 and NVIDIA GPU driver 470.182.03. Through the experiments, the following items are measured.
JCT consistency: The distribution of JCT, which is the time to complete a DT job when another job is being executed.
GPU time: The total sum of the end-to-end usage duration of each GPU required to complete the training of all enqueued DT jobs. This metric indicates the efficiency of the GPU infrastructure.
gSLA satisfaction: Measured by 1) the number of jobs that violated the gSLA, and 2) the violation amount, which is the extent to which the JCT increase (δ) exceeded the gSLA per job.

TABLE 1

| Category | Datasets | Models |
|---|---|---|
| Image | CIFAR-10 | DenseNet-40-12, DenseNet-100-12, |
| classification | | DenseNet-100-24, ResNet-20, ResNet-32, |
| | | ResNet-44, ResNet-56, ResNet-110, |
| | | AlexNet, NASNet |
| | ImageNet | ResNet-50, ResNet-101, ResNet-152, |
| | | AlexNet, OverFeat, GoogleNet, |
| | | InceptionV3, InceptionV4, VGG-11, |
| | | VGG-16, VGG-19, NASNet, MobileNet |
| NLP | Europarl | NMTBig, NMTMedium, NMTSmall, |
| | | Transformer, TransformerANN, |
| | | TransformerBig |

JCT consistency: First, the JCT of the DT jobs is presented. In each experiment, a pair of jobs (combinations) to be executed through GPU sharing is selected. For example, when job A (J_{A}) and job B (J_{B}) are selected as a combination, each worker of J_{A} and J_{B} is executed on a single GPU. In other words, J_{A} and J_{B} are executed concurrently on a single GPU. Subsequently, the experiments are conducted by fixing J_{A} and alternating J_{B}, measuring how much the training speed of J_{A} decreases in each combination.

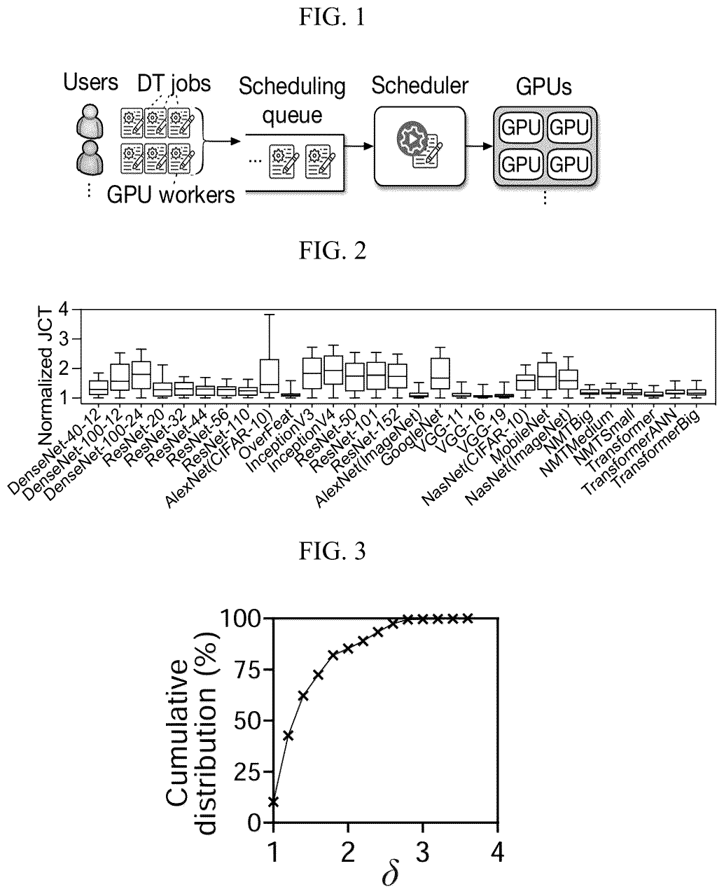

FIG. 2 illustrates the JCT distribution, with the x-axis representing the 29 types of J_{A} in Table 1. The y-axis represents the range of JCT values for J_{A} when executed by alternating J_{B}. Therefore, FIG. 2 includes a total of 841 JCT values. Since the JCT is different for each DT job, the normalization of the JCT is performed using the minimum JCT of each job. Therefore, a value of 2 on the y-axis indicates that the JCT of the job on the x-axis may take twice more time compared to the best (minimum) scenario. On average, the Kubernetes plugin for GPU sharing shows up to a 2× increase in JCT.

Additionally, the JCT increase is considered in comparison to the case of dedicated use. Specifically, the JCT of J_{A} in the dedicated use is measured. Then, by dividing the JCT value of J_{A} obtained through GPU sharing (from the experiment in FIG. 2) by the JCT measured through the dedicated use, the JCT increase (δ) is calculated. FIG. 3 illustrates the cumulative distribution function (CDF) of δ. A δ value of 1 on the x-axis indicates that the training of J_{A} is completed with the same JCT as in the dedicated use. When δ is greater than 1, it means that the JCT has increased (slowed down) compared to the dedicated use. In FIG. 3, the δ values from 435 DT job combinations show a highly varying range, with a maximum value of 3.7, and the average value of δ is 1.5.

The reason for this JCT inconsistency is the different combinations of DT jobs. Even if the jobs originate from the same dataset, the jobs executed together vary due to GPU scheduling. That is, depending on the jobs executed together on the GPU, the interference between the jobs varies. Therefore, appropriate scheduling is required to reduce JCT inconsistency.

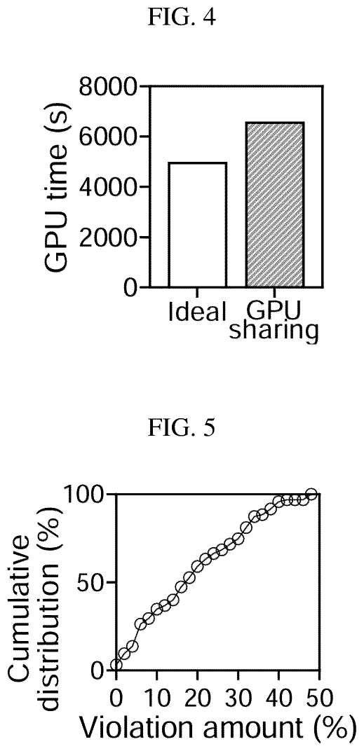

GPU time. As illustrated in FIG. 2 and FIG. 3, the end-to-end time taken to execute the 435 DT job combinations is measured. Through the experiments, the GPU time when the GPU is shared is compared with the GPU time in the ideal scenario. Since two GPU workers are shared on a single GPU, the ideal GPU time for the GPU sharing techniques is defined as half of the dedicated use time, assuming that two identical jobs are executed without any interference. Therefore, the GPU time of dedicated use is measured, and the ideal GPU time is calculated as half of the dedicated use time. FIG. 4 illustrates the ideal GPU time and the GPU time for GPU sharing (Kubernetes plugin). Compared to the ideal, GPU sharing results in approximately 1.32 times longer GPU usage.

gSLA satisfaction. The gSLA satisfaction is shown through the following experiments. 10 DT jobs are created by randomly selecting from the 29 jobs. The 10 created DT jobs are stored in the scheduling queue. For each job, a gSLA is randomly set within the range of 1.0 to 2.0.

As follows, the 10 DT jobs are paired and executed. Initially, the first and second jobs in the scheduling queue are paired and executed. Once one job is completed, the third job is selected and paired with the remaining job (still-running job) to be executed. This process is repeated until all jobs in the queue are completed. For each job, δ is calculated using the method described above. When δ>gSLA, the corresponding job is considered to have violated the gSLA. This experiment is repeated 30 times to evaluate a total of 300 jobs.

As a result, 32% (95 out of 300 jobs) were found to have violated the gSLA. The details of the jobs that violate the gSLA are investigated. FIG. 5 illustrates the cumulative distribution function (CDF) of gSLA violations. The x-axis represents the violation amount, which indicates how much the JCT violated against the gSLA. On average, Kubernetes GPU sharing shows a 19% of violation amounts of the gSLA. At the tail-end (99% percentile value), the violation amounts reach 48%. These experiments demonstrate that the Kubernetes GPU sharing technique shows shortcomings in terms of gSLA satisfaction.

### TensorShare Design

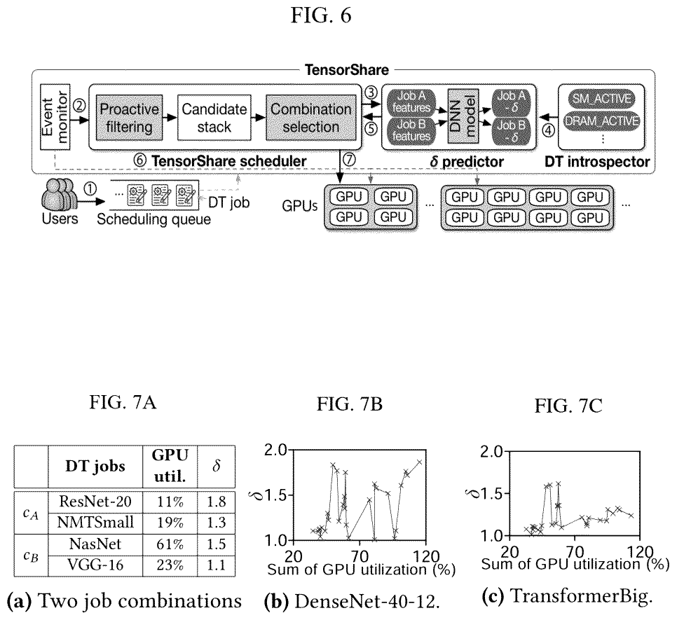

FIG. 6 explains the design of the proposed GPU sharing technique (referred to as TensorShare). The DT jobs submitted by the user are registered in the scheduling queue (\textcircled{1} in FIG. 6). The proposed technique (TensorShare) includes an event monitor that detects changes in job states and GPU states. For example, when a DT job ends its training, the event monitor activates the TensorShare scheduler (which may also be referred to as a scheduler) to determine a DT job to execute (\textcircled{2} in FIG. 6).

To determine which jobs will use the GPUs, the TensorShare scheduler requires the δ values of job combinations. These δ values are obtained through a δ predictor (which may also be referred to as a predictor) as follows (\textcircled{3}). To predict δ, the DT introspector is used to analyze the features of each job in the scheduling queue (e.g., the features of job A in FIG. 6) (\textcircled{4}). The job features include the active durations of the GPU cores and memories. Based on these job features, the δ predictor predicts the δ values for the job combinations. For example, in FIG. 6, the δ predictor takes the features of job A and job B to predict the δ for the two jobs (\textcircled{5}). The prediction is performed for all job combinations in the scheduling queue.

Based on the predicted δ values, the TensorShare scheduler selects job combinations that 1) satisfy the gSLA of jobs and 2) reduces JCT and GPU time (\textcircled{6}). Finally, the selected job combination is executed (\textcircled{7}).

Next, the DT introspector is explained along with the fine-grained GPU metrics for each job, and the structure of the δ predictor is described. Then, the detailed techniques of the TensorShare scheduler, such as proactive filtering and combination selection, are explained.

### DT Introspector

The DT introspector is built for profiling the GPU-related metrics of DT jobs. The profiling is performed with dedicated use because the metrics among jobs vary significantly when the GPU is shared. If profiling is performed with GPU sharing, it is impossible to identify the distinct characteristics of each DT job.

To characterize the DT jobs, resource consumption such as GPU utilization, GPU memory utilization, and GPU memory occupancy are profiled. The GPU utilization refers to the ratio of active duration during which computations are executed on the GPU per second. The GPU memory utilization refers to the amount of read and write operations performed on the GPU memory per second. GPU memory occupancy refers to the amount of GPU memory consumed by the DT job.

Meanwhile, previous studies recognized the existence of interference when the GPU is shared. For example, to analyze the interference, the GPU utilization was measured. These studies concluded that when the average or sum of GPU utilization of DT jobs is high, the interference between jobs becomes more severe. In other words, these studies indirectly analyzed interference using GPU utilization.

To verify this conclusion, the present invention conducted experiments on two job combinations to measure GPU utilization and δ (see FIG. 7A). The two combinations are denoted as c_{A} and c_{B}, respectively. The DT jobs of c_{A} show an average GPU utilization of 15%. The DT jobs of c_{B} show an average GPU utilization of 42%, which is 2.8 times higher than the average GPU utilization of c_{A}. According to previous studies, δ is expected to be higher in c_{B}, which shows a higher average GPU utilization. However, the δ of c_{A} is actually 19% higher than the δ of c_{B}. This experiment shows that GPU utilization alone has limitations in analyzing or predicting δ.

Another example of job combinations from the previously explained experiment is presented. In FIG. 3, out of the 435 job combinations ({J_{A}, J_{B}}), J_{A} is fixed as a DenseNet-40-12. Since J_{B} varies across 29 different DT jobs, 29 unique combinations may be obtained. For each combination, the total GPU utilization of the two DT jobs (J_{A} and J_{B}) is calculated. In this case, the GPU utilization for each job is profiled when executed in dedicated use. This allows obtaining 29 values for the summed GPU utilization. In FIG. 7B, the x-axis represents the sum of the 29 GPU utilization values in ascending order. The y-axis represents the δ of DenseNet-40-12. Similarly, in FIG. 7C, the δ of TransformerBig is shown as GPU utilization increases. Although GPU utilization increases (x-axis), the δ values (y-axis) do not increase, contrary to what was assumed in previous studies. These graphs demonstrate the limitations of GPU utilization.

By deeply analyzing the limitations of GPU utilization, the reasons why GPU utilization is inaccurate for predicting δ are investigated. Specifically, a single GPU includes numerous cores, such as streaming multiprocessors (SMs). The amount and duration that each DT jobs uses SMs significantly vary. However, GPU utilization does not take into account the specific usage in each SM. The GPU utilization metric is defined as the ratio of the active duration during which the GPU device is used for the DT job. For example, even if only one SM out of thousands of SMs is used, the GPU utilization is 100% because the GPU device itself is being used for the DT job. Therefore, GPU utilization cannot explain the individual SM core usage of DT jobs. As a result, the different utilization across SM cores for various DT jobs cannot be captured through GPU utilization.

Therefore, more accurate and fine-grained metrics than GPU utilization are investigated. Metrics on the GPU core and memory, which can be defined and measured using the official NVIDIA tool, datacenter GPU management (DCGM), are considered. After eliminating several metrics that are always constant or near zero, eight fine-grained metrics are selected. Table 2 lists the descriptions and units of the eight selected metrics. All metrics are measured at 100 ms intervals, but profiling may be done with longer measurement intervals. Among these eight metrics, four metrics (i.e., SM_ACTIVE, SM_OCCUPANCY, DRAM_ACTIVE, and PCIE_RX) have been found to be effective for δ prediction and are investigated.

TABLE 2

| Metric | Description | Unit |
|---|---|---|
| SM_ACTIVE | Ratio of active durations in SMS. | % |
| SM_OCCUPANCY | Ratio of the actively occupied amount of | % |
| | SMs. | |
| FP_ACTIVE | Ratio of active durations of 16- and 32-bit | % |
| | floating point commands in SMs. | |
| DRAM_ACTIVE | Ratio of active durations of GPU memory | % |
| | interface. | |
| MEM_COPY | Ratio of active durations for data read or | % |
| | write from to GPU memory. | |
| PCIE_TX | Amount of data transmitted by GPU over | Byte/s |
| | the PCIe bus. | |
| PCIE_RX | Amount of data received by GPU over | Byte/s |
| | PCIe bus. | |
| POWER_USAGE | Amount of GPU power consumption. | W |

### δ Predictor

The details of the δ predictor are explained. First, the input features are determined from the fine-grained GPU metrics. Then, the architecture of the δ predictor is designed, and a neural architecture search (NAS) is performed to train it.

Input Features. Through feature engineering, the input features are identified. The common feature engineering methods are 1) correlation analysis between input features and output features (δ), and 2) similarity analysis between input features. Here, the metrics previously investigated are potential input features.

To perform the two methods, a dataset consisting of 1) fine-grained GPU metrics of a DT job (potential input features) and 2) δ (output feature) is prepared. Recently, public clouds have released several traces on DT workloads and their corresponding logs (e.g., the number of GPU workers). However, no datasets exist for the fine-grained GPU metrics of DT jobs. Therefore, an own dataset is prepared as follows. The 29 DT jobs described above are analyzed to obtain the fine-grained GPU metrics. Additionally, the δ values measured in FIG. 3 are used. In FIG. 3, the experiment includes 435 job combinations. As a result, 870 jobs (two jobs per combination) perform the training, generating their 870 corresponding δ values. For each δ value, the fine-grained GPU metrics of the DT jobs are matched. As a result, a dataset consisting of 870 records is obtained.

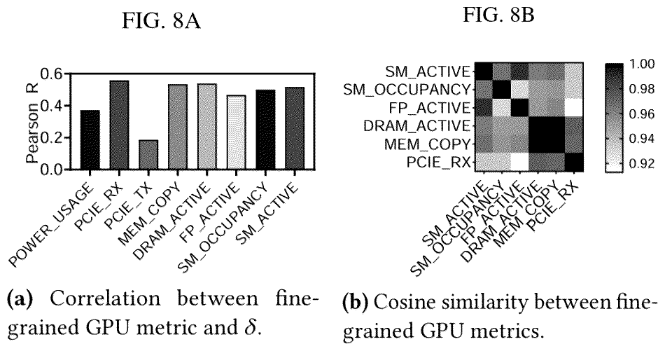

Using this dataset, correlation analysis between the fine-grained GPU metrics and δ is performed. The Pearson coefficient is calculated as a correlation value. A high Pearson coefficient indicates a strong correlation. FIG. 8A shows the Pearson coefficients of the fine-grained GPU metrics for δ. Among the eight metrics, the coefficients for PCIE_TX and POWER_USAGE are lower than 0.4, while others are higher. These results imply that the two metrics show weaker relationships with the δ compared to the other metrics. Therefore, in the present invention, these two metrics are excluded.

Secondly, the similarity between the remaining six metrics is analyzed. Cosine similarity is used to calculate the similarity. The cosine similarity represents the similarity between two metrics, with a maximum value of 1. FIG. 8B shows the results as a heatmap. The darker the cell at the intersection of the x-axis and y-axis, the higher the similarity between the metrics represented on those corresponding axes. According to the results, FP_ACTIVE is very similar to SM_ACTIVE (similarity of 0.991), and MEM_COPY is very similar to DRAM_ACTIVE (similarity of 0.9994). In prediction models, including input features with high similarity increases training time and decreases prediction accuracy. Therefore, in the present invention, FP_ACTIVE (or SM_ACTIVE) and/or MEM_COPY (or DRAM_ACTIVE) are excluded. Finally, at least one of the metrics among SM_ACTIVE (or FP_ACTIVE), SM_OCCUPANCY, DRAM_ACTIVE (or MEM_COPY), and PCIE_RX may be selected as input features. However, according to the embodiment, at least one of the eight input features presented above may be utilized as input features.

Model structure and training. Using the selected input features, the δ predictor is trained with the pre-built dataset. This dataset is divided into a 6:2:2 ratio for model training, model validation during training, and model evaluation.

The structure of the δ predictor is explored through neural architecture search (NAS), which navigates various model structures and hyperparameters (e.g., the number of layers). It was found that a deep neural network (DNN) algorithm based on a multi-layer perceptron (MLP) is the most suitable for the δ predictor. Other machine learning algorithms were not suitable for the GPU metrics. For example, by converting the numeric input features of the & predictor into a 2×2 matrix for processing, a convolutional neural network (CNN) was tested. The CNN took more than twice the training time compared to the DNN but showed accuracy of less than 50%. Other algorithms, such as long short term memory (LSTM), also performed worse than the DNN. However, according to the embodiment, the prediction model forming the δ predictor may also be generated by training any neural network model.

Through NAS, various model structure options such as the number of MLP layers, activation functions, optimizers, batch size, learning rate, dropout rate, and batch normalization are navigated. AutoKeras, a widely used tool for NAS, may be used. When running NAS, a model navigation strategy needs to be determined. Since the dataset is not large, the Bayesian strategy is selected to explore the search space. Specifically, the Bayesian strategy uses past training results regarding model structure and prediction accuracy to increase the probability of finding a more optimized model in the next navigation. The & predictor is trained using a dataset generated by the NVIDIA V100 GPU. The δ predictor may also be trained or retrained on new datasets for other GPU types. It was confirmed that the δ predictor with 10 MLP layers showed the highest accuracy.

### TensorShare Scheduler

The TensorShare scheduler determines job combinations that satisfy the gSLA. The scheduler is activated 1) when the GPU cluster and scheduling queue are initialized, and 2) when a DT job completes its training. For ease of explanation, the scheduling queue is represented as SQ={J₁, J₂, . . . , Jₙ}, where Jᵢ is the i-th DT job in the SQ, and n (n being an arbitrary natural number) jobs exist in the SQ. For the first case (initialization), the scheduler selects the first job (J₁) from the SQ and finds another job from the SQ that can be executed together with J₁ as a combination. For the second case, when a DT job completes its training, another job that has not yet finished its training continues to use the GPU. Therefore, the TensorShare scheduler searches for a new job from the SQ.

The term J_{R} is used to represent 1) J₁ in the first case and 2) the remaining (still-running) job in the second case. Therefore, for n jobs in the SQ, the TensorShare scheduler has potential n combinations of ci={J_{R}, Jᵢ}. Here, Jᵢ is a DT job in the SQ. The scheduler considers whether each cᵢ satisfies the corresponding gSLA. The possible combinations are denoted as C=∪_{1≤i≤n}cᵢ.

Proactive filtering. The TensorShare scheduler satisfies the gSLAs by avoiding violations through proactive filtering. Proactive filtering involves examining all cᵢ in C. For each cᵢ, proactive filtering requests the δ predictor to predict δ. Specifically, the input features of J_{R} and Jᵢ included in cᵢ, i.e., a total of eight values (four fine-grained GPU metrics each for J_{R} and Jᵢ), are provided as input. Then, the δ predictor generates δ for each of J_{R} and Jᵢ. The two predicted δ values for cᵢ are denoted as

$${D}^{{c}_{i}} = \{ {δ}_{{J}_{R}}^{{c}_{i}} , {δ}_{{J}_{i}}^{{c}_{i}} \} .$$

### The δ of J_{R}

$$( {δ}_{{J}_{R}}^{{c}_{i}} )$$

varies depending on Jᵢ. Therefore, the δ of J_{R} is distinguished by notating cᵢ by an upper superscript of δ_{J}_{_{R}}. The TensorShare scheduler obtains n number of D^{c}^{ᵢ} for all cᵢ in C.

Based on the D^{c}^{ᵢ}, proactive filtering checks whether cᵢ may satisfy the gSLAs. The gSLAs of cᵢ is denoted as {gSLA_{J}_{_{R}}, gSLA_{Ji}}. If either

$${δ}_{{J}_{R}}^{{c}_{i}} or {δ}_{{J}_{i}}^{{c}_{i}}$$

has a higher value than gSLA_{J}_{_{R}} or gSLA_{Ji}, it indicates a gSLA violation in at least one of DT jobs. Therefore, cᵢ may not be executed as a combination (GPU sharing). Therefore, proactive filtering excludes ci from the potential combinations (C). Conversely, when both J_{R} and Jᵢ satisfy the gSLAs, proactive filtering adds cᵢ to its “candidate stack” (STA). Therefore, the STA is defined as follows.

$$STA = \{ {c}_{i} \vert {δ}_{{J}_{R}}^{{c}_{i}} \leq {gSLA}_{{J}_{R}} , {δ}_{{J}_{i}}^{{c}_{i}} \leq {gSLA}_{{J}_{i}} , {c}_{i} ∈ C \}$$

Another consideration in proactive filtering is the prediction errors from the δ predictor. Assume that for J_{R} from cₖ={J_{R}, Jₖ}, the predicted

$${δ}_{{J}_{R}}^{{c}_{k}}$$

is 1.95, but the actual

$${δ}_{{J}_{R}}^{{c}_{k}}$$

value when J_{R} is trained together with Jₖ is 2.1. When the gSLA for J_{R} is 2, scheduling and executing cₖ on the GPUs is a gSLA violation (2.1>2). However, since the predicted

$${δ}_{{J}_{R}}^{{c}_{k}}$$

is lower than the gSLA_{J}_{_{R}}, proactive filtering includes cₖ in the STA. To avoid this situation, the gSLAs may be adjusted to a lower value. In the previous example, when the gSLA is reduced by 10%, the adjusted gSLA value becomes 1.8. Since the adjusted gSLA is lower than the predicted

$${δ}_{{J}_{R}}^{{c}_{k}} ,$$

proactive filtering identifies cₖ as a gSLA violation and excludes it from the STA. In the present invention, through the experiments, a method of decreasing the gSLA by 5% (multiplying by 95%) is selected. However, the factor by which the gSLA is multiplied may be variable depending on the embodiment.

After examining gSLA satisfactions for all cᵢ, proactive filtering counts the number of cᵢ in the STA. If the STA is empty, it means that no combinations exist to execute GPU sharing with gSLA satisfaction for J_{R}. Therefore, TensorShare executes J_{R} without GPU sharing (dedicated use). If there is one cᵢ in the STA, it means that only one combination is possible for J_{R}. Then, TensorShare directly executes cᵢ and terminates its scheduling. If there are two or more cᵢ in the STA, TensorShare proceeds to combination selection to determine the optimal cᵢ for execution.

Combination selection. After proactive filtering, the cᵢ in the STA are expected to satisfy gSLAs. In combination selection, a selection strategy is designed to select one cᵢ from the STA for execution. Two aspects are considered in designing the selection strategy to benefit both 1) individual DT jobs (users), and 2) overall GPU efficiency. In case of individual jobs, the goal is to reduce the JCT. In case of GPU efficiency, the goal is to reduce GPU time. First, the design of the selection strategy is explored by considering the individual DT jobs.

To reduce the JCT of each job, a simple approach is to prioritize selecting the job with less δ. The JCT of a job (Jₖ) is determined by δJₖ multiplied by the JCT when Jₖ is trained by dedicated use. The JCT of dedicated use remains unchanged, but δJₖ varies for each cᵢ. Therefore, the JCT reduction depends on the values of D^{c}^{ᵢ}. A selection strategy is designed by selecting a combination with less δ of jobs, thereby reflecting the JCT reduction. This strategy is referred to as S₁ and is expressed as follows. The DT job included in the job combination, where the sum of δ for each of two DT jobs is minimized, may be selected.

$${min}_{{c}_{i} ∈ STA} ( {δ}_{{J}_{R}}^{{c}_{i}} + {δ}_{{J}_{i}}^{{c}_{i}} )$$

However, when only considering JCT reduction, it was observed that GPU time may be significantly worsened. This conflicts with the second aspect of the selection strategy design. This issue is demonstrated through an experiment comparing two scenarios: (1) a scenario where cᵢ is selected through S₁, and (2) a scenario where the cᵢ (first one) is selected from the STA without any strategy (FIFO). Each experiment is conducted as follows. 20 jobs are maintained in the SQ. The TensorShare scheduler is activated 50 times in each experiment. Each time a job in the SQ is scheduled and executed, a new job (one of the 29 DT jobs) is randomly added into the SQ to maintain 20 jobs. The experiment described above is repeated 20 times, performing 1000 scheduling rounds in total.

In each scheduling round, the number of cᵢ in the STA is counted to check whether GPU sharing is possible. When the STA is empty, it means that J_{R} needs to be executed by dedicated use to satisfy the gSLAs. Dedicated use leads to worse GPU time as the GPUs are used solely for one job, thereby increasing the total time and amount of GPU infrastructure required to accomplish the enqueued jobs in the SQ. Therefore, an empty STA needs to be avoided for higher GPU sharing opportunities and better GPU time. The two bars in FIG. 10, FIFO and S₁, represent the experimental results. When using the S₁ strategy, the empty STA occurs 1.5 times more frequently compared to the case with FIFO. This means that 1.5 times more DT jobs may not utilize GPU sharing when using S₁ compared to FIFO.

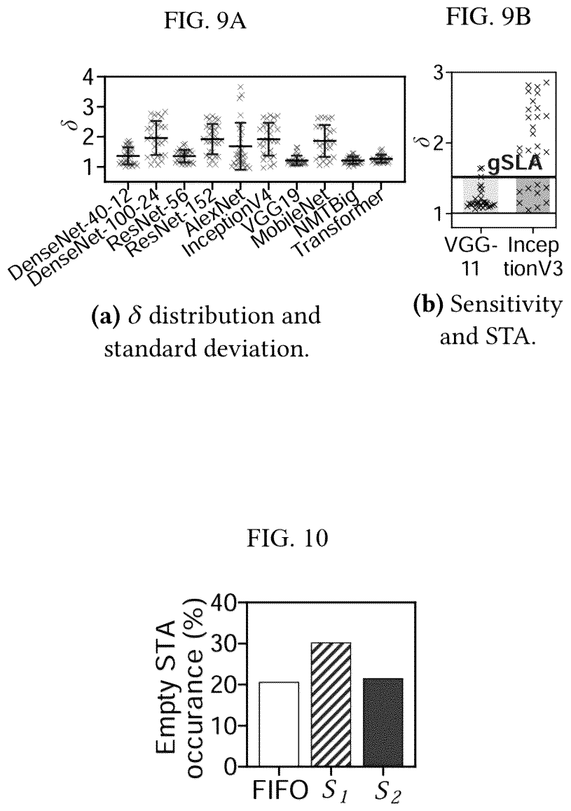

To increase GPU sharing opportunities, the novel characteristic of DT jobs, which is referred to as sensitivity, is considered. Sensitivity may represent the variance of δ for each DT job. The variance may be explained through the 435 combinations measured in FIG. 3 (with J_{A} is fixed and J_{B} alternating). The variance is calculated by standard deviation. That is, sensitivity in the present invention may refer to the standard deviation or variance. FIG. 9A shows the standard deviation of δ for 10 randomly selected J_{A} (x-axis) from 29 jobs. Each point in the graph represents an individual δ value of J_{A} (x-axis) as J_{B} alternates. The whisker bars above the dots represent the standard deviation values for each J_{A}. According to the graph, the sensitivity varies greatly depending on the DT jobs, ranging from 0.12 (NMTBig) to 0.78 (AlexNet), representing a 6.6-fold difference.

Now, the relationship between sensitivity and the occurrence of the empty STA is discussed using the example in FIG. 9B. FIG. 9B shows the δ values for two DT jobs, VGG-11 and InceptionV3. The standard deviations (sensitivity) for these two jobs are 0.16 and 0.59, respectively, indicating that a much wider range of δ for InceptionV3. Assume that the gSLAs of the two jobs are set at 1.5 (gSLAs in FIG. 9B). VGG-11 may be executed with 26 jobs (×marks in the shaded area on the left). This is because these jobs allow VGG-11 to achieve δ<1.5. In contrast, InceptionV3 may be executed with only nine jobs (×marks in the shaded area on the right) which is 2.9 times lower than VGG-11.

This implies that InceptionV3 has fewer opportunities to encounter DT jobs as combinations that satisfy the gSLAs. Therefore, it is advantageous to prioritize InceptionV3, which exhibits higher sensitivity, by executing the job as a combination (GPU sharing) as much as possible. This observation may be incorporated into S₁ to derive an improved strategy, S₂, which is expressed as follows. According to the Equation below, the job combination with the minimum sum of δ/sensitivity for the DT jobs forming the combination may be selected.

$${min}_{{c}_{i} ∈ STA} ( {δ}_{{J}_{R}}^{{c}_{i}} / {Sensitivity}_{{J}_{R}} + {δ}_{{J}_{i}}^{{c}_{i}} / {Sensitivity}_{{J}_{i}} )$$

To evaluate the effect of S₂, a scheduling experiment is conducted in a manner similar to the one previously described. FIG. 10 shows the empty STA occurrence frequency of FIFO, S₁, and S₂. From the 1000 scheduling rounds, S₂ reduces the high occurrence frequency of empty STA in S₁ to a level similar to that of FIFO (with the difference from FIFO being only 0.9%). Since S₂ may consider JCT reduction and GPU time together, the TensorShare scheduler may use S₂ as the combination selection strategy.

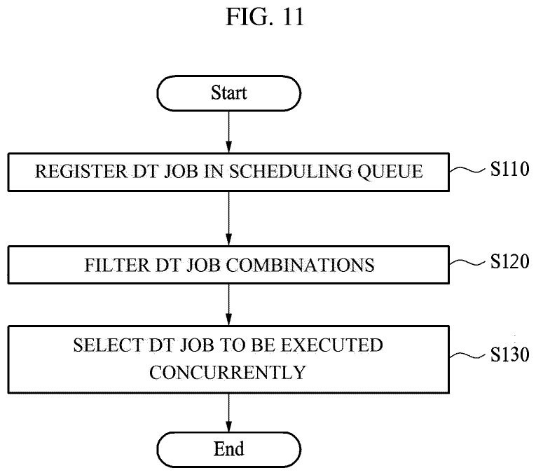

FIG. 11 is a flowchart for explaining a scheduling method according to an embodiment of the present invention. The scheduling method may be performed by a computing device that includes at least a processor and/or memory. Therefore, at least some of the steps constituting the scheduling method may be understood as operations of a processor included in the computing device, and the computing device may be referred to as the scheduling device. Additionally, the computing device may be implemented as a single device or as multiple devices to form a distributed environment.

Additionally, the scheduling method illustrated in FIG. 11 is a method for selecting DT jobs to be executed concurrently, either when 1) the GPU cluster and/or scheduling queue are initialized, or 2) when the training of a DT job on one of the GPUs in the GPU cloud is completed. Hereinafter, in describing the scheduling method, details that are redundant with the previous description will be omitted.

First, a DT job is received from a user (which may refer to a user terminal), and the received DT job is registered in the scheduling queue (S110). At this point, a predetermined number of DT jobs (for example, n DT jobs) may be maintained in the scheduling queue. In other words, when a DT job registered in the scheduling queue is scheduled and executed, a new DT job is registered in the scheduling queue, ensuring that the predetermined number of DT jobs is maintained in the scheduling queue.

At initialization, after the first registered DT job among the DT jobs has been registered in the scheduling queue is scheduled on one of the GPUs, the following processes may be performed to select the DT job to be executed concurrently, or to select another DT job to be executed concurrently when the training of one DT job of the DT job combinations currently running on a GPU is completed.

A filtering operation for the DT job combinations is performed (S120). When a pre-scheduled DT job or a DT job that is still being executed is referred to as a first DT job, filtering is performed for each DT job registered in the scheduling queue and the combination with the first DT job. The filtering is performed based on whether the DT job combinations satisfy the gSLAs. The satisfaction of the gSLAs is determined by comparing the δ (JCT increase) of each of two DT jobs in the DT job combination with the gSLA. When at least one DT job included in the DT job combination has a δ that is greater than (or equal to or greater than) the gSLA for the corresponding DT job, the corresponding DT job combination is filtered out. That is, only the DT job combinations consisting of DT jobs with the δ smaller than (or equal to or smaller than) the corresponding gSLA are not filtered out and are set as candidate DT job combinations.

In this case, the adjusted gSLA, which is compared with the δ, may be used. For example, by multiplying the gSLA received from the user for the corresponding DT job by a predetermined factor, a more strengthened (or reduced) gSLA may be used for comparison, thereby eliminating the issue of δ prediction error. Additionally, the δ for each DT job may be generated by inputting the input features of the DT jobs forming the DT job combination into the δ predictor (or δ prediction model). The input features may be at least one of the eight features described above. In addition, the δ predictor may be built by training an arbitrary neural network model using pre-built training data.

Additionally, the input features for each DT job may be generated through profiling. NVIDIA's DCGM may be utilized as a profiling tool, but the present invention is not limited thereto. Any profiling tool capable of extracting the input features utilized to predict δ may be used. According to an embodiment, the input features for the DT job may also be extracted by performing only at least part of the training for the DT job.

After the filtering of the DT job combinations, a DT job to be executed concurrently is selected (S130). In this case, when there is only one candidate DT job combination, the DT job included in the candidate combination (another DT job different from the first DT job) is selected as the DT job to be executed concurrently. As a result, the selected DT job is scheduled and executed together with the first DT job.

When there are multiple candidate DT job combinations, a combination selection operation is performed to select one of the DT job combinations. The combination selection operation may: 1) randomly select one DT job combination from the candidate DT job combinations, 2) select the DT job combination that was registered first in the scheduling queue from the candidate DT job combinations, 3) select a DT job combination based on the S₁ selection strategy, or 4) select a DT job combination based on the S₂ selection strategy.

When selecting a DT job combination based on the S₂ selection strategy, sensitivity (standard deviation or variance of δ) information for the DT job is required. In this case, it may be calculated by predicting δ using the input features for the DT job for which the sensitivity is to be calculated and the input features for other DT jobs as inputs. Here, the other DT jobs may refer to DT jobs for which profiling operation has previously been performed and/or DT jobs that are registered in the scheduling queue. The input features may be generated using profiling tools or may be pre-generated and stored.

Through the aforementioned process, once the DT job to be executed concurrently with the first DT job is selected, the selected DT job and the first DT job may form a combination and be executed concurrently on a single GPU.

The device described above can be implemented as hardware elements, software elements, and/or a combination of hardware elements and software elements. For example, the device and elements described with reference to the embodiments above can be implemented by using one or more general-purpose computer or designated computer, examples of which include a processor, a controller, an ALU (arithmetic logic unit), a digital signal processor, a microcomputer, an FPGA (field programmable gate array), a PLU (programmable logic unit), a microprocessor, and any other device capable of executing and responding to instructions. A processing device can be used to execute an operating system (OS) and one or more software applications that operate on the said operating system. Also, the processing device can access, store, manipulate, process, and generate data in response to the execution of software. Although there are instances in which the description refers to a single processing device for the sake of easier understanding, it should be obvious to the person having ordinary skill in the relevant field of art that the processing device can include a multiple number of processing elements and/or multiple types of processing elements. In certain examples, a processing device can include a multiple number of processors or a single processor and a controller. Other processing configurations are also possible, such as parallel processors and the like.

The software can include a computer program, code, instructions, or a combination of one or more of the above and can configure a processing device or instruct a processing device in an independent or collective manner. The software and/or data can be tangibly embodied permanently or temporarily as a certain type of machine, component, physical equipment, virtual equipment, computer storage medium or device, or a transmitted signal wave, to be interpreted by a processing device or to provide instructions or data to a processing device. The software can be distributed over a computer system that is connected via a network, to be stored or executed in a distributed manner. The software and data can be stored in one or more computer-readable recorded medium.

A method according to an embodiment of the invention can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc., specially designed to store and execute program instructions. Examples of the program instructions may include not only machine language codes produced by a compiler but also high-level language codes that can be executed by a computer through the use of an interpreter, etc. The hardware mentioned above can be made to operate as one or more software modules that perform the actions of the embodiments of the invention and vice versa.

Although the present invention is described with reference to the example embodiments illustrated in the drawings, it is provided as an example only and it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents. Therefore, other implementations, other example embodiments, and equivalents are within the scope of the following claims.

What is claimed is:

1. A scheduling method performed by a computing device, comprising:
receiving a distributed training job (DT job) from at least one user to register the DT job in a scheduling queue;
generating candidate DT job combinations by filtering multiple DT job combinations, each consisting of one pre-scheduled first DT job in one of GPUs included in a GPU cluster and one of the DT jobs registered in the scheduling queue; and
selecting a DT job to be executed concurrently with the first DT job in the one of the GPUs.

2. The scheduling method of claim 1, wherein a predetermined number of DT jobs are maintained in the scheduling queue.

3. The scheduling method of claim 1, wherein the generating of the candidate DT job combinations includes:
filtering the multiple DT job combinations based on whether each of the multiple DT job combinations satisfying a GPU service level agreement (gSLA).

4. The scheduling method of claim 1, wherein the generating of the candidate DT job combinations includes:
extracting input features of each DT jobs included in each of the multiple DT job combinations;
predicting a JCT increase (δ) by inputting the extracted input features into a pre-trained job completion time (JCT) increase prediction model;
determining whether to satisfy a gSLA based on a JCT increase of each of DT jobs included in the DT job combination; and
filtering DT job combinations that do not satisfy the gSLA.

5. The scheduling method of claim 4, wherein the determining of whether to satisfy the gSLA includes:
determining that the gSLA is satisfied when JCT increases of all DT jobs included in the DT job combination are smaller than the gSLA.

6. The scheduling method of claim 4, wherein the input features include at least one of SM_ACTIVE, SM_OCCUPANCY, DRAM_ACTIVE, or PCIE_RX.

7. The scheduling method of claim 4, wherein the pre-trained JCT increase prediction model includes a deep neural network (DNN) structure based on a multi-layer perceptron (MLP).

8. The scheduling method of claim 1, wherein the selecting of the DT job includes:
selecting DT jobs included in the candidate DT job combination as DT jobs to be executed concurrently on the one of the GPUs, in case that there is only one candidate DT job combination.

9. The scheduling method of claim 1, wherein the selecting of the DT job includes:
selecting DT jobs included in DT job combination with a smallest sum of JCT increases of each of DT jobs, among the candidate DT job combinations, as DT jobs to be executed concurrently on the one of GPUs.

10. The scheduling method of claim 1, wherein the selecting of the DT job includes:
selecting DT jobs included in DT job combination with a smallest sum of JCT increase/(standard deviation of JCT increase) of DT jobs, among the candidate DT job combinations, as DT jobs to be executed concurrently on the one of GPUs.
